(19) United States
(12) Patent Application Publication
(10) Pub. No.: US 2004/0008474 A1
(43) Pub. Date: Jan. 15, 2004

(54) LED backlight system for a computer display

(76) Inventors: James P. Kardach, Saratoga, CA (US); Andrew C. Barker, Sonning (GB); David Williams, Newark, CA (US); Mike J. Rocke, Pleasanton, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/193,800

(22) Filed: Jul. 11, 2002

(51) Int. Cl. G06F 1/16; G02F 1/1333

(52) U.S. Cl. 361/681; 361/683; 349/58

(57) ABSTRACT

In one embodiment of the invention the apparatus includes a light emitting diode (LED) to emit source light, a light converter coupled with said LED to convert said source light into converted light, and a liquid crystal display matrix (LCD matrix) coupled with said light-converting screen to receive said converted light.

### FIELD OF THE INVENTION

Embodiments of the invention relate to the field of computers, and more specifically, computer displays.

### BACKGROUND OF THE INVENTION

Notebook computers are lightweight personal computers. Currently, notebook computers are relatively lightweight and are small enough to fit in a briefcase. Aside from size, a major difference between notebook computers and personal computers is the graphical display system. Notebook computer designers employ a variety of techniques to produce lightweight graphical display systems.

FIG. 1 shows a typical notebook computer. A notebook computer 100 typically includes a liquid crystal display (LCD) 102 for displaying graphical images, and a backlight for illuminating the LCD 102. Often, the backlight includes a florescent tube 104 for generating light used by the LCD 102. As shown in FIG. 1, a typical notebook computer also includes an inverter 106 (described below), which is powered by a battery 108.

One disadvantage of a florescent tube backlight is that its power consumption is relatively high. Florescent tube backlights often consume as much as fifty percent of a notebook computer's power. Moreover, florescent tube backlights require relatively high voltages to cause fluorescence. More specifically, a florescent tube backlight requires hundreds of volts to be generated from a low voltage power source (e.g., a battery 108) to emit light. An inverter 106 is often used to convert a twelve-volt power supply into the hundreds of volts required for causing the florescent tube backlight to fluoresce. One disadvantage of the florescent tube backlight is that a relatively high quantity of power is lost during this conversion.

Often when notebook computers are operated where ambient light is relatively bright (e.g., outside on a sunny day), the backlight does not provide enough light for displaying graphical images at a suitable brightness. That is, in bright light conditions, images shown on the LCD 102 appear to lack luminosity. One disadvantage is that backlights often lack the necessary brightness to overcome such dim image display.

### BRIEF DESCRIPTION OF THE DRAWINGS

The invention may best be understood by referring to the following description and accompanying drawings that are used to illustrate embodiments of the invention. The numbering scheme for the figures included herein are such that the leading number for a given element in a figure is associated with the number of the figure. In the drawings:

FIG. 1 shows a typical notebook computer.

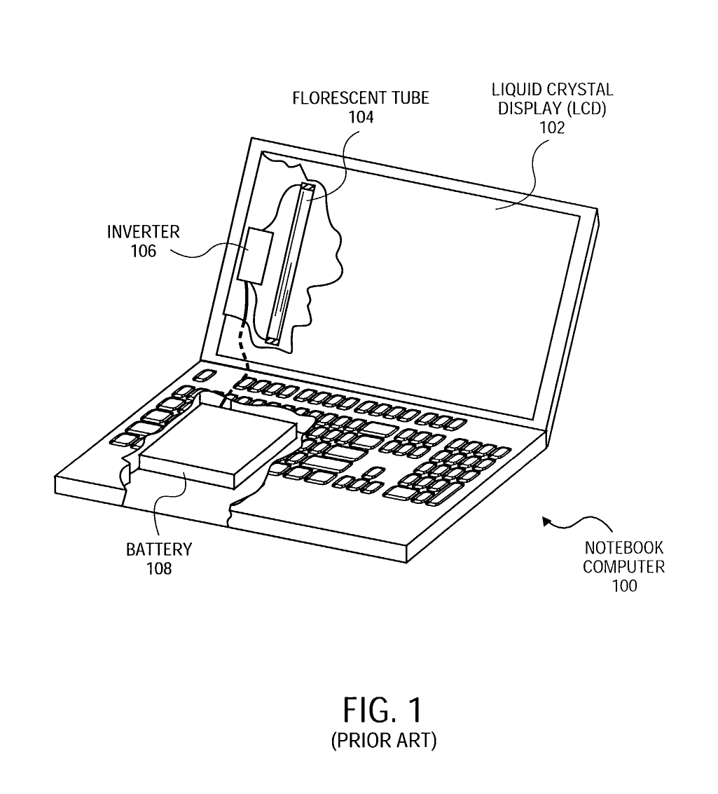

FIG. 2 illustrates a light emitting diode (LED) backlight for a notebook computer display system, according to one embodiment of the invention.

FIG. 3 illustrates an LED backlight and a light converter, according to one embodiment of the invention.

FIG. 4 is a block diagram illustrating a back light system and liquid crystal display, according to embodiments of the invention.

FIG. 5 is a flow diagram illustrating the operations of a back light system and liquid crystal display.

FIG. 6 is a block diagram illustrating an alternative back light system and liquid crystal display.

FIG. 7 is a flow diagram illustrating the operations of an alternative back light system and liquid crystal display.

FIG. 8 illustrates a notebook computer with a reflective surface for reflecting ambient light into the computer's backlight system.

FIG. 9 illustrates an exemplary system comprising an LCD with LED backlight system, according to embodiments of the invention.

### DETAILED DESCRIPTION

In the following description, numerous specific details are set forth. However, it is understood that embodiments of the invention may be practiced without these specific details. In other instances, well-known circuits, structures, and techniques have not been shown in detail in order not to obscure the understanding of this description.

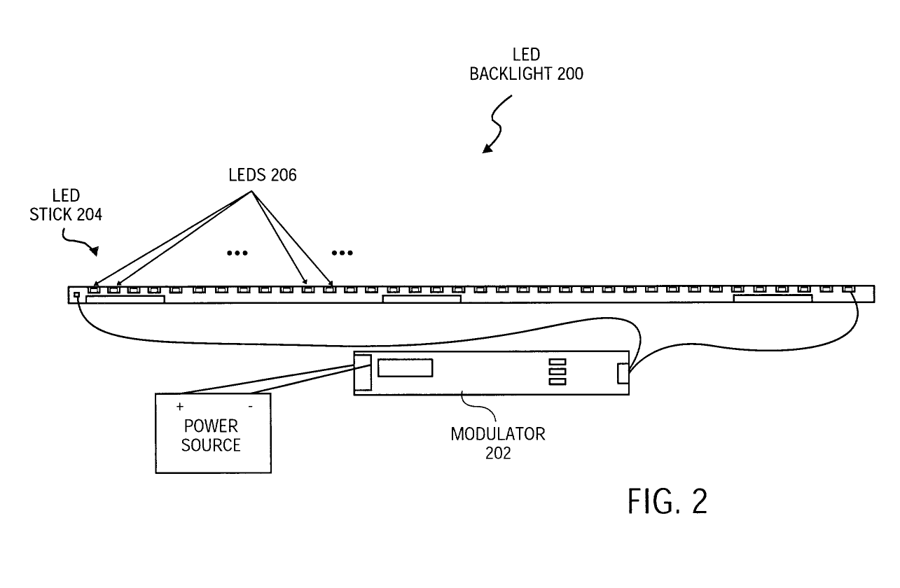

FIG. 2 illustrates a light emitting diode (LED) backlight for a notebook computer display system, according to one embodiment of the invention. According to an embodiment of the invention, the LED backlight 200 includes a modulator 202, and an LED stick 204. The LED stick 204 includes a number of LEDs 206. For example, according to an embodiment of the invention, the LED stick 204 includes 36 LEDs. In an alternative embodiment of the invention, the LED stick 204 includes 18 LEDs. According to other embodiments of the invention, the LED stick 204 includes a greater or lesser number of LEDs (e.g., 1 LED or 48 LEDs.). The LEDs 206 are blue LEDs, according to one embodiment of the invention. However, according to an alternative embodiment of the invention, the LEDs 206 are ultraviolet LEDs.

The modulator 202 receives power from a battery (e.g., a 12 volt battery), according to an embodiment of the invention. According to an alternative embodiment of the invention, the modulator 202 receives power from a rectified AC power source (e.g., through a plug-in AC to DC adapter).

Typically, when non-white light is used to illuminate LCD systems, the nonwhite light is converted into light that may be used to display an image. For example, colored light is converted into light usable by the red, green, and blue color masks of an LCD matrix (i.e., the light is converted into red, green and blue light).

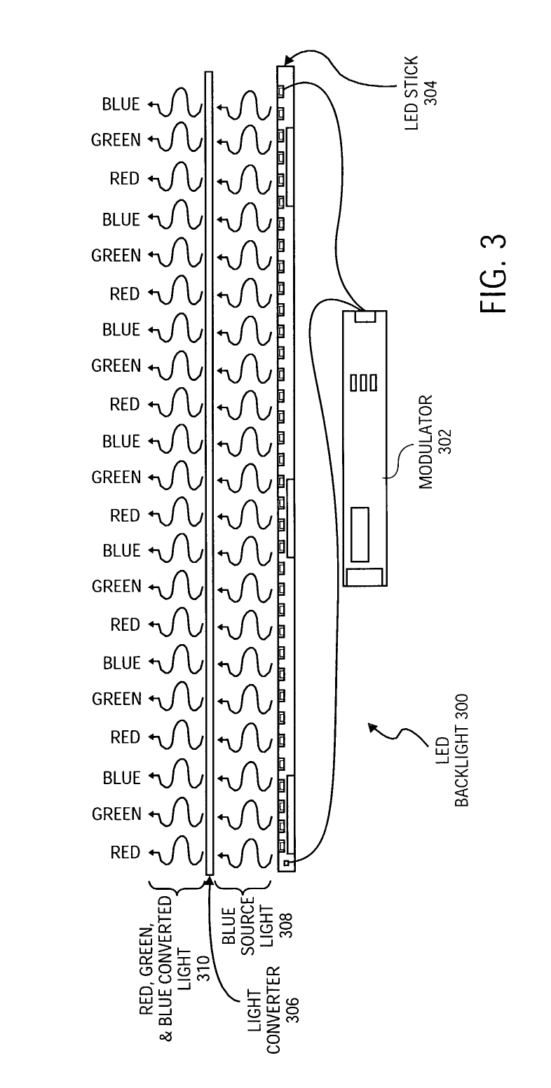

FIG. 3 illustrates an LED backlight and a light converter, according to one embodiment of the invention. In FIG. 3, there is a light converter 306 and an LED backlight 300, which includes a modulator 302 and an LED stick 304, similar to those described above with reference to FIG. 2. According to one embodiment of the invention, the light converter 306 is a host material impregnated with light converting dye. In one embodiment of the invention, the host material is a poly-methyl-methylmethacrylete (PMMA) film, and the light converting dye is the fluorescent dye Rhodamine 6G. However, it should be understood that alternative embodiments of the invention call for other host materials. Moreover, alternative embodiments of the invention call for other suitable light converting dyes. Light converting dyes such as Rhodamine 6G absorb light of one color and emit light of different colors. For example, such dyes absorb blue source light with an energy band of 430-470 nm (370 nm for ultraviolet) and through a Quantum effect emit red, green, and blue light. For example, with respect to FIG. 3, Rhodimine 6G causes the light converter 306 to absorb light from the blue part of the spectrum and re-emit light in the red, green, and blue parts of the spectrum.

According to the exemplary embodiment of the invention shown in FIG. 3, the light converter 306 receives blue source light 308 emitted from the LED backlight 300 and converts it into red converted light, green converted light and blue converted light, which is the red, green, and blue converted light 310. Alternatively, the light converter 306 receives ultraviolet light and converts it into red, green and blue converted light 310.

The LED backlight 300 and light converter 306 may be incorporated into a computer display to generate and convert light used for rendering images.

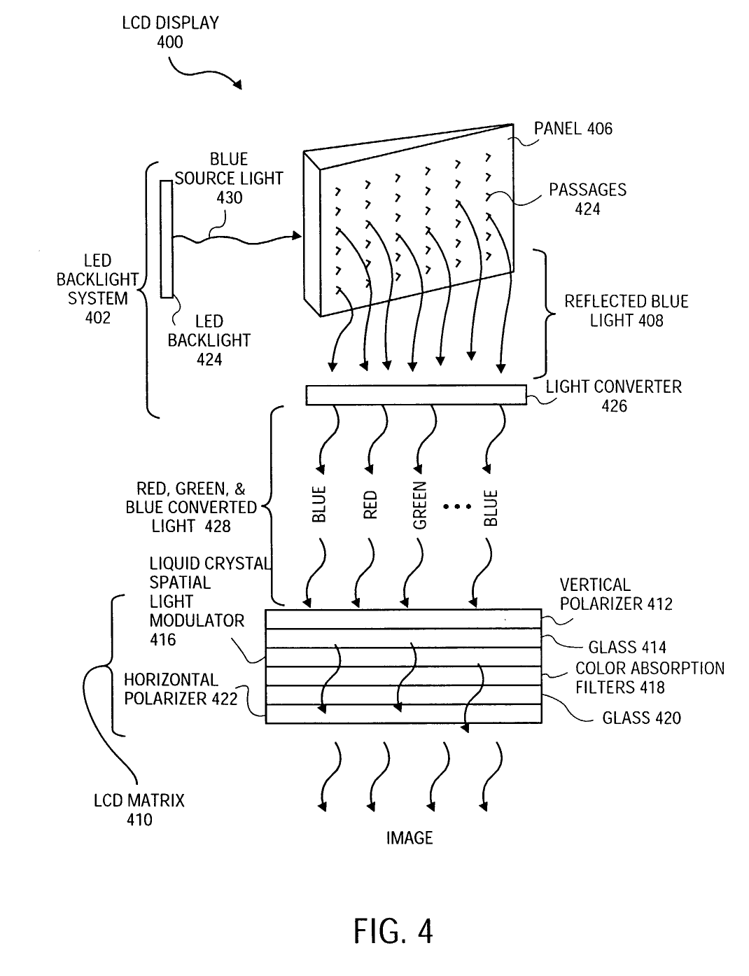

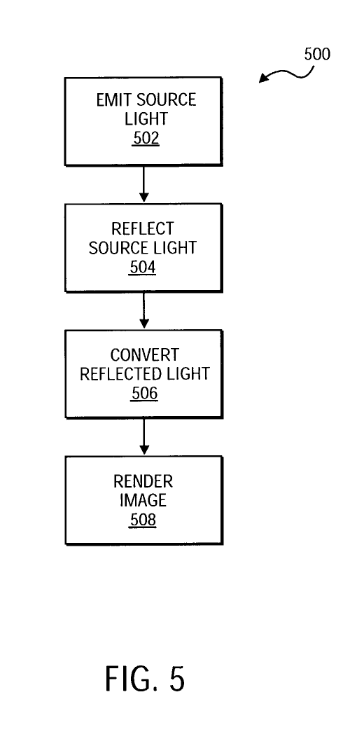

FIG. 4 is a block diagram illustrating a back light system and liquid crystal display matrix, according to embodiments of the invention. In FIG. 4, an LCD display 400 includes an LED backlight system 402 and an LCD matrix 410. The LED backlight system 402 includes an LED backlight 424, panel 406, and light converter 426. The LED backlight 424 and light converter 426 are similar to those described above, with reference to FIG. 3. The panel 406 is described below. The LCD matrix 410 includes a vertical polarizer 412, glass 414, liquid crystal spatial light modulator 416, color absorption filters 418, glass 420, and a horizontal polarizer 422. These components will be described in greater detail below. Moreover, the operations of the LED backlight system 402 and the LCD matrix 410 will be described below with reference to FIG. 5.

According to one embodiment of the invention, the panel 406 is used to reflect light. In one embodiment of the invention, the panel 406 is wedge-shaped. However, the panel 406 may be shaped in any other suitable fashion (e.g. box-shaped). In one embodiment of the invention, the panel 406 includes passages 424, which are organized to evenly distribute the reflected light. For example, the passages 424 are organized in columns that are spaced closer together as they are located further from the LED backlight 424.

In one embodiment of the invention, in the LCD matrix 410, the vertical polarizer 412 vertically polarizes the red, green, and blue converted light 428. Furthermore, the liquid crystal spatial light modulator 416 and the color absorption filters 418 are sandwiched between glass 414 and glass 420. In one embodiment of the invention, thin film transistors (TFTs) (not shown) etched on the glass 414 and glass 420 control which parts of the liquid crystal spatial light modulator 416 are illuminated when an image is rendered (i.e., the TFTs control which pixels are switched on when rendering an image). The horizontal polarizer 422 horizontally polarizes the light passing through the LCD matrix 410. According to alternative embodiments of the invention, the LCD matrix 410 could be arranged differently with additional or fewer components. The operations of the LED backlight system 402 and LCD matrix 410 will be described below with reference to FIG. 5.

FIG. 5 is a flow diagram illustrating the operations of a back light system and liquid crystal display. The operation of the flow diagram of FIG. 5 will be described with reference to the exemplary back light system and liquid crystal display of FIG. 4. However, it should be understood that operations of the flow diagram of FIG. 5 could be performed by embodiments of the invention other than those discussed with reference to the block diagram of FIG. 4, and embodiments of the invention discussed with reference to the block diagram of FIG. 4 could perform operations different than those discussed with reference to the flow diagram of FIG. 5.

At block 502, source light is emitted. With reference to the exemplary embodiment of the invention shown in FIG. 4, the LED backlight 424 emits a blue source light 430. However, according to an alternative embodiment of the invention, the LED backlight 424 emits an ultraviolet source light.

As shown at block 504, the source light is reflected. For example, the panel 406 reflects the blue source light 430 90°. More specifically, after receiving the blue source light 430, the panel 406 reflects the blue source light 430 90° through its passages 424 in the form of reflected blue light 408. Alternative embodiments of the invention reflect the source light at different angles (e.g. 30°, 60°).

As shown in block 506, the reflected light is converted. For example, as the reflected blue light 408 light passes through the light converter 426, the light converter 426 converts it into red, green, and blue converted light 428. In an alternative embodiment of the invention, ultraviolet is converted into red, green, and blue converted light 428.

At block 508, an image is rendered. For example, referring to the exemplary embodiment of the invention of FIG. 4, LCD matrix 410 renders an image with the light that it receives. More specifically, the red, green and blue converted light 428 travels through the vertical polarizer 412, glass 414, liquid crystal spatial light modulator 416, color absorption filters 418, glass 420, and horizontal polarizer 422, to generate image.

As indicated above, alternative embodiments of the invention do not include all of the elements shown in the block diagrams and/or do not perform all of the operations indicated in the flow diagrams. For example, referring to FIG. 5, in an alternative embodiment of the invention, the source light is not reflected (e.g., the operation at process block 504 is omitted). For example, referring to FIG. 4, the backlight system 402 would not include panel 406, as the LED backlight 424 would be located such that the blue source light 430 would shine directly into the light converter 426 and LCD matrix 410 without being reflected by the panel 406. In such an embodiment of the invention, the other operations shown in FIG. 5 would be performed as described above.

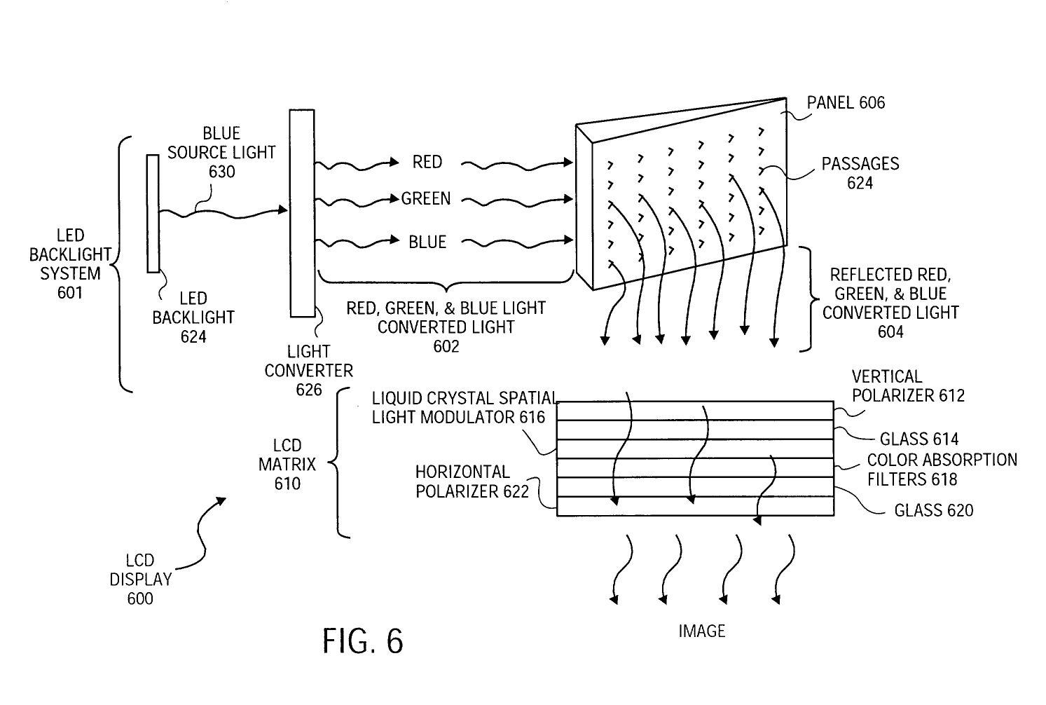

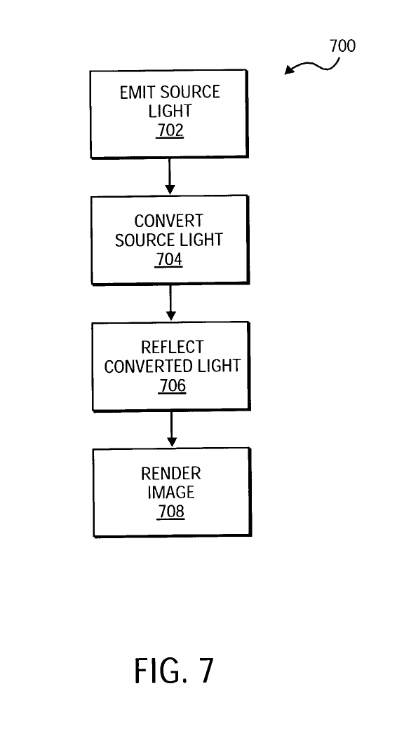

FIG. 6 is a block diagram illustrating an alternative backlight system and liquid crystal display. In FIG. 6, an LCD display 600 includes an LED backlight system 601 and LCD matrix 610. The back light system 601 includes an LED backlight 624, light converter 626, and panel 606, similar to those described above, with reference to FIGS. 3 and 4. The components of the LED backlight system 624 shown in FIG. 6 are arranged differently than those shown in FIG. 5. Notably, the light converter 626 is positioned in between the LED backlight 624 and the panel 606. The LCD matrix 610 includes a vertical polarizer 612, glass 614, liquid crystal spatial light modulator 616, color absorption filters 618, glass 620, and horizontal polarizer 622, similar to those described above, with reference to FIG. 4. The operations of the LED backlight system 601 and LCD matrix 610 will be described with reference to FIG. 7 below.

FIG. 7 is a flow diagram illustrating the operations of an alternative back light system and liquid crystal display. The operation of the flow diagram of FIG. 7 will be described with reference to the exemplary alternative back light system and liquid crystal display of FIG. 6. However, it should be understood that operations of the flow diagram of FIG. 7 could be performed by embodiments of the invention other than those discussed with reference to the block diagram of FIG. 6, and embodiments of the invention discussed with reference to the block diagram of FIG. 6 could perform operations different than those discussed with reference to the flow diagram of FIG. 7.

At block 702, source light is emitted. For example, the LED backlight 624 emits the blue source light 630. According to an alternative embodiment of the invention, the LED backlight 624 emits an ultraviolet source light.

As shown in block 704, source light is converted. In the exemplary embodiment of the invention of FIG. 6, the blue source light 630 passes through the light converter 626, which converts the blue source light 630 into red, green and blue converted light 602. In an alternative embodiment of the invention, ultraviolet is converted into red, green, and blue converted light 602.

At block 706, the converted light is reflected. For example, the panel 606 reflects the red, green, and blue converted light 602 90°. More specifically, after receiving the red, green, and blue converted light 602, the panel 606 reflects the red, green, and blue converted light 602 90° through its passages 624 in the form of reflected red, green, and blue converted light 604. Alternative embodiments of the invention reflect the converted light at different angles (e.g. 30°, 60°).

As shown in block 708, an image is rendered. The reflected red, green and blue converted light 604 travels into the LCD matrix 610. The LCD matrix 610 uses the reflected red, green and blue converted light 604 to render an image by passing it through the vertical polarizer 612, glass 614, liquid crystal spatial light modulator 616, color absorption filters 618, glass 620, and horizontal polarizer 622.

In bright ambient light conditions, ambient light may be used to brighten a notebook computer display. For example, bright sunlight may be used as an additional light source to augment a notebook computer's backlight system.

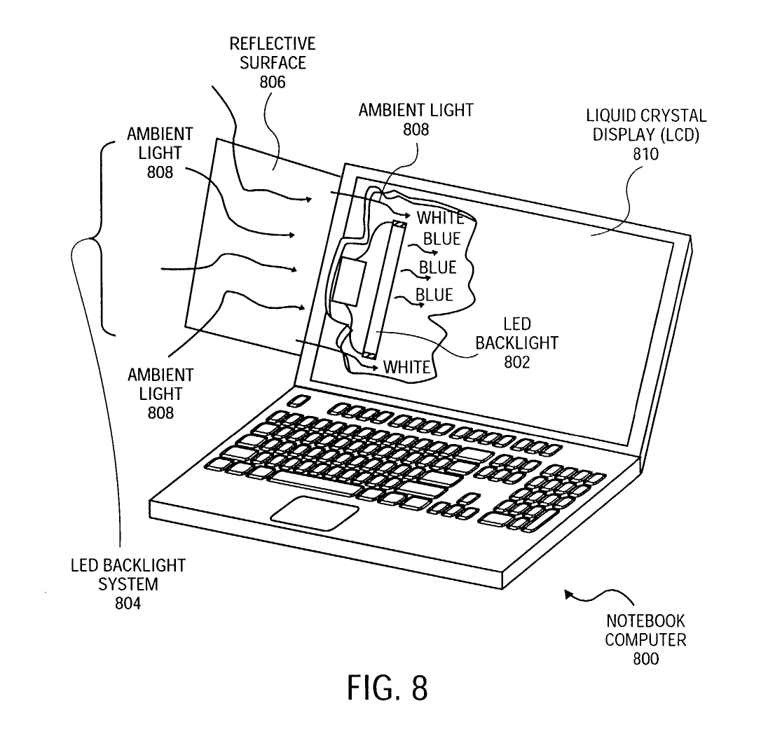

FIG. 8 illustrates a notebook computer with a reflective surface for reflecting ambient light into the computer's backlight system. Typically, as shown in FIG. 8, ambient light is white, while the light emitted from the LED backlight 802 is blue (as described above). In FIG. 8, a notebook computer 800 includes an LCD display 810, which includes an LED backlight system 804, and LCD matrix (not shown).

The LED backlight system 804 is similar to the LED backlight system described with reference to FIG. 4, although not all the components are shown in FIG. 8. In particular, the LED backlight system 804 includes an LED backlight 802, light converter (not shown), and panel (not shown). Additionally, the LED backlight system 804 includes a reflective surface 806 for reflecting ambient light 808 into the LED backlight system 804. For example, the reflective surface 806 reflects ambient light into the panel (not shown) and light converter (not shown). According to one embodiment of the invention the ambient light travels first through the light converter and then the panel, while in an alternative embodiment the invention, the ambient light travels first through the panel and then the light converter. After passing through the light converter and panel (or panel and light converter), the converted ambient light travels into the LCD matrix to be used in rendering an image, as described above with respect to FIGS. 4, 5, 6, and 7. In an embodiment of the invention, the light converter includes dyes that react to energy bands which are plentiful in ambient light sources to generate additional light for the LCD matrix.

In one embodiment of the invention, the reflective surface 806 is retractable. For example, the reflective surface 806 can fold into the notebook computer's outer shroud (e.g., it can fold into the notebook computer's plastic cover). Alternatively, the reflective surface 806 can fold flush with the notebook computer's outer shroud. According to an alternative embodiment of the invention, the reflective surface 806 is held in a fixed position.

Embodiments of the invention are not limited to including just one reflective surface 806. An alternative embodiment of the invention includes two reflective surfaces; one on each side of the LCD 802. Moreover, the reflective surface 806 may be any shape. For example, the reflective surface 806 can be round or square. The reflective surface may also be concave, convex, or otherwise contoured. For example it may be round and concave like a satellite dish.

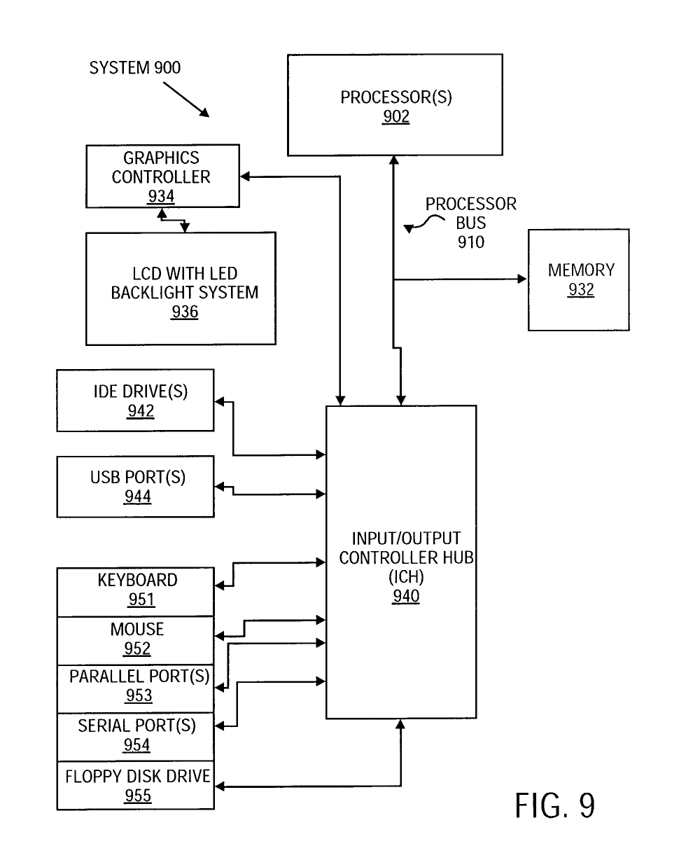

FIG. 9 illustrates an exemplary system comprising an LCD with LED backlight system, according to embodiments of the invention. Although described in the context of system 900, the present invention may be implemented in any suitable computer system comprising one or more integrated circuits.

As illustrated in FIG. 9, computer system 900 comprises processor(s) 902. Computer system 900 also includes a memory 932, processor bus 910 and input/output controller hub (ICH) 940. The processor(s) 902, memory 932 and ICH 940 are coupled to the processor bus 910. The processor(s) 902 may comprise any suitable processor architecture and for one embodiment of the invention comprise an Intel® Architecture used, for example, in the Pentium® family of processors available from Intel® Corporation of Santa Clara, Calif. For other embodiments of the invention, computer system 900 may comprise one, two, three, or more processors, any of which may execute a set of instructions that are in accordance with embodiments of the present invention.

The memory 932 stores data (e.g., image data) and/or instructions, and may comprise any suitable memory, such as a dynamic random access memory (DRAM), for example. A graphics controller 934 controls the display of information on an LCD display with LED backlight system 936, according to embodiments of the invention.

The input/output controller hub (ICH) 940 provides an interface to I/O devices or peripheral components for computer system 900. The ICH 940 may comprise any suitable interface controllers to provide for any suitable communication link to the processor(s) 902, memory 932 and/or to any suitable device or component in communication with the ICH 940. For one embodiment of the invention, the ICH 940 provides suitable arbitration and buffering for each interface.

For one embodiment of the invention, the ICH 940 provides an interface to one or more suitable integrated drive electronics (IDE) drives 942, such as a hard disk drive (HDD) or compact disc read only memory (CD ROM) drive for example, to store data and/or instructions for example, one or more suitable universal serial bus (USB) devices through one or more USB ports 944. For one embodiment of the invention, the ICH 940 also provides an interface to a keyboard 951, a mouse 952, a floppy disk drive 955, one or more suitable devices through one or more parallel ports 953 (e.g., a printer), and one or more suitable devices through one or more serial ports 954.

Accordingly, computer system 900 includes a machine-readable medium on which is stored a set of instructions (i.e., software) embodying any one, or all, of the methodologies described herein. For example, software can reside, completely or at least partially, within memory 932 and/or within processor(s)s 902. For the purposes of this specification, the term “machine-readable medium” shall be taken to include any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Thus, a method and apparatus for an LED backlight system for a computer display have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An apparatus comprising:
a light emitting diode (LED) to emit source light;
a light converter coupled with said LED to convert said source light into converted light; and
a liquid crystal display matrix (LCD matrix) coupled with said light converter to receive said converted light.

2. The apparatus of claim 1, wherein the source light is blue.

3. The apparatus of claim 1, wherein the source light is ultraviolet.

4. The apparatus of claim 1 further comprising:
a panel coupled with said LED to receive said source light and to reflect said source light through said light converter into said LCD matrix.

5. The apparatus of claim 4 further comprising:
a reflective surface coupled to said panel to reflect ambient white light into said panel, wherein said panel is to reflect said ambient white light through said light converter into said LCD matrix.

6. The apparatus of claim 1, wherein said light converter is to convert said source light into red converted light, green converted light, and blue converted light.

7. The apparatus of claim 6, wherein said light converter is a polymer film impregnated with dye to react to energy bands of said source light

8. The apparatus of claim 1 further comprising:
a panel coupled with said light converter to reflect said converted light into said LCD matrix.

9. An apparatus comprising:
a light emitting diode (LED) to emit a source light;
a modulator coupled to said LED to control power flow to said LED;
a light converter coupled with said LED to convert said source light into red converted light, green converted light, and blue converted light; and
a liquid crystal display matrix (LCD matrix) to display an image generated with said red converted light, green converted light, and blue converted light.

10. The apparatus of claim 9, wherein the source light is blue.

11. The apparatus of claim 9, wherein the source light is ultraviolet.

12. The apparatus of claim 9 wherein the light converter comprises:
a florescent dye; and
a film impregnated with said florescent dye.

13. The apparatus of claim 9 further comprising:
a panel coupled with said LED to receive said source light and to reflect said source light through said light converter into said LCD matrix.

14. The apparatus of claim 13 further comprising:
a reflective surface coupled to said panel to reflect ambient white light into said panel, wherein said panel is to reflect said ambient white light through said light converter into said LCD matrix, wherein said light converter is to convert said ambient white light into red converted light, green converted light, and blue converted light.

15. The apparatus of claim 9 further comprising:
a panel coupled to said light converter to reflect said converted light into said LCD matrix.

16. A system comprising:
a memory to store instructions and image data;
a processor coupled to said memory to execute said instructions and to process said image data;
a display device coupled with said processor to display an image based on said image data comprising, a light emitting diode (LED) to emit a source light;
a modulator coupled to said LED to control power transmitted to said LED;
a light converter coupled with said LED to convert said source light; and
a liquid crystal display matrix (LCD matrix) coupled with said light converter to render said image with said converted light.

17. The system of claim 16 wherein said source light is blue.

18. The system of claim 16 wherein said source light is ultraviolet.

19. The system of claim 16, wherein said light converter is to convert said source light into red converted light, green converted light, and blue converted light.

20. The system of claim 19, wherein said light converter comprises:
a florescent dye; and
a film impregnated with said florescent dye.

21. The system of claim 16 wherein display device further comprises:
a panel coupled with said LED to receive said source light and to reflect said source light through said light converter into said LCD matrix.

22. The system of claim 16 where in said display device further comprises:
a panel coupled with said light converter to reflect said converted light into said LCD matrix.

23. A method comprising:
emitting a source light from a light emitting diode;
converting with a dye coated film said source light into red converted light, green converted light, and blue converted light; and
rendering an image on a liquid crystal display matrix (LCD matrix) with said red converted light, green converted light, and blue converted light.

24. The method of claim 23 wherein said source light is blue.

25. The method of claim 23 wherein said source light is ultraviolet.

26. The method of claim 23 further comprising:
reflecting ambient white light through said dye coated film into said LCD matrix.

27. The method of claim 23 further comprising:
reflecting said source light before said converting.

28. The method of claim 23 further comprising:
reflecting said converted red light, said converted green light, and said converted blue light into said LCD matrix.
